(19) United States
(12) Patent Application Publication
(10) Pub. No.: US 2011/0176762 A1
(43) Pub. Date: Jul. 21, 2011

(54) OPTICAL MODULATOR AND OPTICAL MODULATOR FABRICATION METHOD

(76) Inventors: Junichi Fujikata, Tokyo (JP); Toshio Baba, Tokyo (JP); Jun Ushida, Tokyo (JP)

(21) Appl. No.: 13/120,625

(22) PCT Filed: Nov. 10, 2009
(86) PCT No.: PCT/JP2009/069110

§ 371 Date: Mar. 23, 2011

(30) Foreign Application Priority Data
Nov. 13, 2008 (JP) 2008-290903

(51) Int. Cl. G02F 1/025; B05D 5/12

(52) U.S. Cl. 385/2; 427/64

(57) ABSTRACT

An optical modulator is formed with at least a portion of a semiconductor layer (8) that has undergone a doping process to exhibit a first conductivity and at least a portion of a semiconductor layer (9) that has undergone a doping process to exhibit a second conductivity overlapping with a dielectric layer (11) interposed. The surface of the semiconductor layer (8) of first conductivity has an uneven form in the portion in which the semiconductor layer (8) that exhibits first conductivity and the semiconductor layer (9) that exhibits second conductivity overlap with the dielectric layer (11) interposed. The dielectric layer (11) is formed on the semiconductor layer (8) of first conductivity that has the uneven form, and the semiconductor layer (9) of second conductivity is formed on the dielectric layer (11).

### TECHNICAL FIELD

The present invention relates to an optical modulator that is necessary in the information processing and communication fields and that converts high-speed electrical signals to optical signals at high speed and to a fabrication method of the optical modulator; and more particularly, relates to an optical modulator that uses a capacitor construction composed of silicon-insulator-silicon that is formed on an SOI (Silicon on Insulator) substrate and to a fabrication method of the optical modulator.

### BACKGROUND ART

Optical fiber communication that was chiefly used for business has now come to be widely used in repidences. This popularization has been accompanied by a demand for high-performance optical communication devices. Among the various optical communication devices for optical communication systems such as local area networks (LAN) and optical fiber for residential use are included silicon-base optical communication devices that function at the optical signal wavelengths of 1330 nm and 1500 nm. These silicon-base optical communication devices hold great promise, and more specifically, enable the integration of optical functional elements and electronic circuits on a silicon platform through the use of CMOS (Complementary Metal Oxide Semiconductor) technology.

As silicon-base optical communication devices, passive devices such as waveguides, optical couplers, and wave filters are being researched on a broad scale. In addition, active devices such as silicon-base optical modulators and optical switches can be offered as examples of important elements of means for managing optical signals for the previously mentioned optical communication systems and are now the focus of attention. An optical switch or optical modulator that uses the thermo-optic effect of silicon to alter refractive index has a slow optical modulation speed and therefore can only be used in devices having an optical modulation frequency that is no greater than 1 Mb/second. Optical modulators that employ the electro-optical effect are necessary for devices having greater optical modulation frequency.

Pure silicon does not exhibit change in the refractive index due to the Pockels effect and changes in the refractive index due to the Franz-Keldysh effect or Kerr effect are extremely small. As a result, most optical modulators that employ the electro-optical effect that are currently proposed employ the carrier-plasma effect. In other words, changing the free carrier density in silicon layers changes the real parts and imaginary parts of the refractive index and thus changes the phase and intensity of light.

The free carrier density in an optical modulator can be changed by the injection, accumulation, elimination, or inversion of free carrier. Most optical modulators that have been investigated to date have poor optical modulation efficiency, require a length of at least 1 mm for optical phase modulation, or require an injection current density higher than 1 kA/cm³. A device configuration that obtains higher optical modulation efficiency is necessary to realize an optical modulator having smaller size, higher integration, and lower power consumption. Obtaining higher optical modulation efficiency enables a reduction of the length necessary for optical phase modulation. In addition, a large optical communication device is prone to the effect of temperature on the silicon substrate, and a change in the index of refraction of the silicon layer resulting from the thermo-optic effect is believed to cancel the electro-optic effect that was to be obtained to begin with.

FIG. 1 is an example of a silicon-base optical modulator of the related art that employs a rib waveguide formed on a SOI (Silicon on Insulator) substrate. Embedded oxide layer 2 and intrinsic semiconductor 1 that includes a rib-shaped portion are successively stacked on substrate 3. p+-doped semiconductor 4 and n+ doped semiconductor 5 are formed on both sides and spaced from the rib-shaped portion of intrinsic semiconductor 1. p+-doped semiconductor 4 and n+-doped semiconductor 5 are formed by subjecting parts of intrinsic semiconductor 1 to a high-concentration doping process. The configuration of the optical modulator shown in FIG. 1 is a PIN (P-intrinsic-N) diode. When forward and reverse bias voltages are applied to the PIN diode, the free carrier density in intrinsic semiconductor 1 changes and the index of refraction changes due to the carrier plasma effect. In this example, electrode contact layer 6 is arranged on one side of the rib-shaped portion of intrinsic semiconductor 1, and previously described p+-doped semiconductor 4 is formed at a position that confronts this electrode contact layer 6. Similarly, electrode contract layer 6 is arranged on the other side of the rib-shaped portion of intrinsic semiconductor 1 and n+-doped semiconductor 5 is formed at a position that confronts this electrode contact layer 6. In addition, a waveguide that includes the rib-shaped portion is covered by oxide cladding 7. In the configuration of the above-described PIN diode, a high-concentration doping process can be used to bring the carrier densities of semiconductors 4 and 5 to the order of 10²⁰/cm³.

During optical modulation operations, a forward bias voltage is applied to the PIN diode from a power supply that is connected to electrode contact layer 6, and free carrier is injected into the waveguide. At this time, the increase of the free carrier causes the index of refraction of intrinsic semiconductor 1 to change and brings about phase modulation of light that is propagated through the waveguide. However, the speed of this optical modulation operation is limited by the free carrier life inside the rib shape of intrinsic semiconductor 1 and carrier diffusion when a forward bias voltage is removed. An optical modulator having this type of PIN diode construction of the related art has typically an operating speed within the range 10-50 Mb/sec when a forward bias voltage is applied. In contrast, although the switching speed can be increased by introducing an impurity into intrinsic semiconductor 1 to shorten carrier life, the impurity that is introduced entails the drawback of reducing the optical modulation efficiency. The greatest factor influencing the operating speed is the RC time constant, and the static capacitance during the application of a forward bias voltage becomes extremely great due to the reduction of the carrier depletion layer of the PN junction. Theoretically, high-speed operation of the PN junction can be achieved by applying a reverse bias voltage, but this approach necessitates a comparatively high drive voltage or large element size.

As another example of the related art, JP-A-2006-515082 (hereinbelow, referred to as “Patent Document 1”) discloses a silicon-base optical modulator having a capacitor construction in which embedded oxide layer 2 and a main region of a first conductivity are successively stacked on substrate 3, the optical modulator being composed of this main region and a gate region of a second conductivity that is stacked so as to partially overlap with the main region, a thin dielectric layer 11 being formed on the lamination interface. Hereinbelow, “thin” will indicate the submicron order (less than 1 μm).

FIG. 2 shows a silicon-base optical modulator composed of an SIS (Silicon-Insulator-Silicon) construction according to the related art. The optical modulator is formed on an SOI substrate that is made up of substrate 3, embedded oxide layer 2, and a main region. The main region is made up of p-doped semiconductor 8 that is formed by a doping process on the silicon layer of the SOI substrate, p+-doped semiconductor 4 formed by a doping process at high concentration, and electrode contact layer 6. The gate region is made up of n-doped semiconductor 9 that is formed by a doping process on a thin silicon layer stacked on the SOI substrate, n+-doped semiconductor 5 that is formed by a doping process at high concentration, and electrode contact layer 6. Oxide cladding 7 is then included in the gaps between embedded oxide layer 2, the main region, and the gate region and above the main region and gate region.

In the areas subjected to the doping processes, change in the carrier density is controlled by an outside signal voltage. When voltage is applied to electrode contact layer 6, the free carrier is accumulated, eliminated, or inverted on both sides of dielectric layer 11, whereby optical phase modulation is effected. As a result, regions of optical signal fields preferably coincide with regions in which the carrier density is dynamically controlled from the outside.

### SUMMARY OF THE INVENTION

Although optical phase modulation is possible in the method of Patent Document 1, the thickness of regions in which the carrier density changes dynamically is extremely thin, i.e., in the order of several tens of nm. As a result, an optical modulation length in the millimeter order (1 mm or more) becomes necessary, the size of the optical modulator increases, and high-speed operation becomes problematic. Accordingly, regarding silicon-base optical modulators that can be integrated on a silicon substrate, it is difficult to realize an optical modulator that is based on the carrier plasma effect that allows the realization of low cost, low current density, low power consumption, high degree of modulation, low-voltage drive, and high-speed modulation in a region in which thickness is in the submicron order (less than 1 μm).

It is an object of the present invention to provide an optical modulator and a method of fabricating the optical modulator that can solve the problems described hereinabove regarding the difficulty of miniaturizing an optical modulator while providing high-phase and high-speed modulation degree.

In the optical modulator of the present invention, at least one portion of a semiconductor layer that has undergone a doping process to exhibit a first conductivity and at least one portion of a semiconductor layer that has undergone a doping process to exhibit a second conductivity are stacked together with a dielectric layer interposed. In the portion in which the semiconductor layer that exhibits the first conductivity and the semiconductor layer that exhibits the second conductivity are stacked together with dielectric layer interposed, the surface of the semiconductor layer of the first conductivity has an uneven form. The dielectric layer is formed on the semiconductor layer of the first conductivity that has the uneven form, and the semiconductor layer of the second conductivity is formed on the dielectric layer.

### BRIEF DESCRIPTION OF THE DRAWINGS

FIG. 1 is a schematic block diagram of an example of an optical modulator of the related art;

FIG. 2 is a schematic block diagram of another example of an optical modulator of the related art;

FIG. 3 is a schematic view of an exemplary embodiment of the optical modulator of the present invention;

FIG. 4 is a sectional view taken along line AA′ of the optical modulator shown in FIG. 3;

FIG. 5 is a schematic view of another exemplary embodiment of the optical modulator of the present invention;

FIG. 6A is a schematic view of yet another exemplary embodiment of the optical modulator of the present invention as seen from the direction of light propagation;

FIG. 6B is a sectional view taken along line BB′ of the optical modulator shown in FIG. 6A;

FIG. 6C is a sectional view taken along line CC′ of the optical modulator shown in FIG. 6A;

FIG. 7A shows the first step of the fabrication process of the optical modulator shown in FIG. 3;

FIG. 7B shows the fabrication process that follows FIG. 7A;

FIG. 7C shows the fabrication process that follows FIG. 7B;

FIG. 7D shows the fabrication process that follows FIG. 7C;

FIG. 8A shows the fabrication process that follows FIG. 7D;

FIG. 8B shows the fabrication process that follows FIG. 8A;

FIG. 8C shows the fabrication process that follows FIG. 8B;

FIG. 8D shows the fabrication process that follows FIG. 8C;

FIG. 9 shows the fabrication process that follows FIG. 8D;

FIG. 10 shows the relation between the optical modulation length and the optical phase shift amount in an optical modulator of the prior art and the optical modulator of the present invention;

FIG. 11 shows the relation between the carrier density and frequency band in an optical modulator of prior art and the optical modulator of the present invention; and

FIG. 12 is a schematic view of a Mach-Zehnder interferometer-type optical intensity modulator that uses the optical modulator of the present invention.

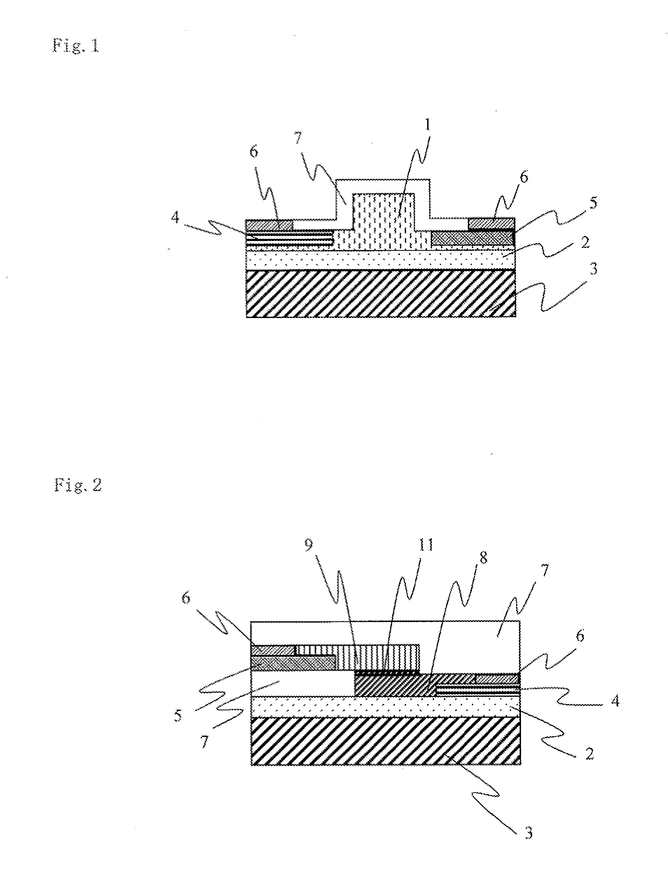

### BEST MODE FOR CARRYING OUT THE INVENTION

Exemplary embodiments of the present invention are next described based on the accompanying drawings. Constructions having identical functions are given the same numbers in the accompanying drawings and redundant explanation of these constructions may be omitted.

Before describing a typical construction of the optical modulator of the present invention, the mechanism of modulation of the carrier density within a silicon layer, which is the basis of the operation of the present invention, will first be explained. The silicon-base optical modulator of the present invention uses the carrier plasma effect that is next described.

As previously described, pure silicon does not exhibit change of the index of refraction due to the Pockels effect, and changes in the index of refraction due to the Franz-Keldysh effect or Kerr effect are extremely small. As a result, only the carrier plasma effect and thermo-optic effect can be used in optical modulation operations. However, an optical modulator that uses the thermo-optic effect to change the index of refraction has a slow modulation speed. Accordingly, only carrier diffusion due to the carrier plasma effect is effective for the purpose of the high-speed operation (1 Gb/sec or more) that is the object of the present invention. Change in the index of refraction due to the carrier plasma effect is explained by the following first-order approximation value of the relation expression that is derived from Kramers-Kronig relations and the Drude equation.

$$\begin{matrix}Δ n = - \frac{{e}^{2} {λ}^{2}}{8 {π}^{2} {c}^{2} {ɛ}_{0} n} ( \frac{Δ {N}_{e}}{{m}_{e}} + \frac{Δ {N}_{k}}{{m}_{k}} ) & [ Equation 1 ] \\ Δ k = - \frac{{e}^{3} {λ}^{2}}{8 {π}^{2} {c}^{3} {ɛ}_{0} n} ( \frac{Δ {N}_{e}}{{m}_{e}^{2} {μ}_{e}} + \frac{Δ {N}_{k}}{{m}_{k}^{2} {μ}_{k}} ) & [ Equation 2 ]\end{matrix}$$

Here, Δn and Δk represent the real part and imaginary part of the change in the index of refraction of a silicon layer, e represents electric charge, λ, represents the wavelength of light, ∈₀ represents the dielectric constant in a vacuum, n represents the index of refraction of intrinsic silicon, mₑ represents the effective mass of electron carriers, mₕ represents the effective mass of hole carriers, μₑ represents the mobility of electron carriers, μₕ represents the mobility of hole carriers, ΔNₑ represents the change in concentration of electron carriers, and ΔNₕ represents the change in concentration of hole carriers. The experimental appraisal of the carrier plasma effect in silicon was carried out, and it was found that the change in the index of refraction with respect to carrier density at the optical communication wavelengths of 1330 nm and 1500 nm that are used in an optical communication system agreed well with the results found by the equations shown above. In addition, in an optical modulator that uses the carrier plasma effect, the amount of phase change is defined by the following equation:

$$Δθ = \frac{2 π}{λ} Δ {n}_{eff} L \qquad [ Equation 3 ]$$

where L is the length of the active layer along the direction of light propagation of the optical modulator.

Because the amount of phase change due to the carrier plasma effect is comparatively great compared to the amount of phase change due to the field absorption effect, the optical modulator described hereinbelow is basically able to exhibit special qualities as a phase modulator.

An optical modulator that uses the free carrier plasma effect and that includes a capacitor construction having a silicon-dielectric layer-silicon on an SOI (Silicon on Insulator) substrate according to the present invention is next described.

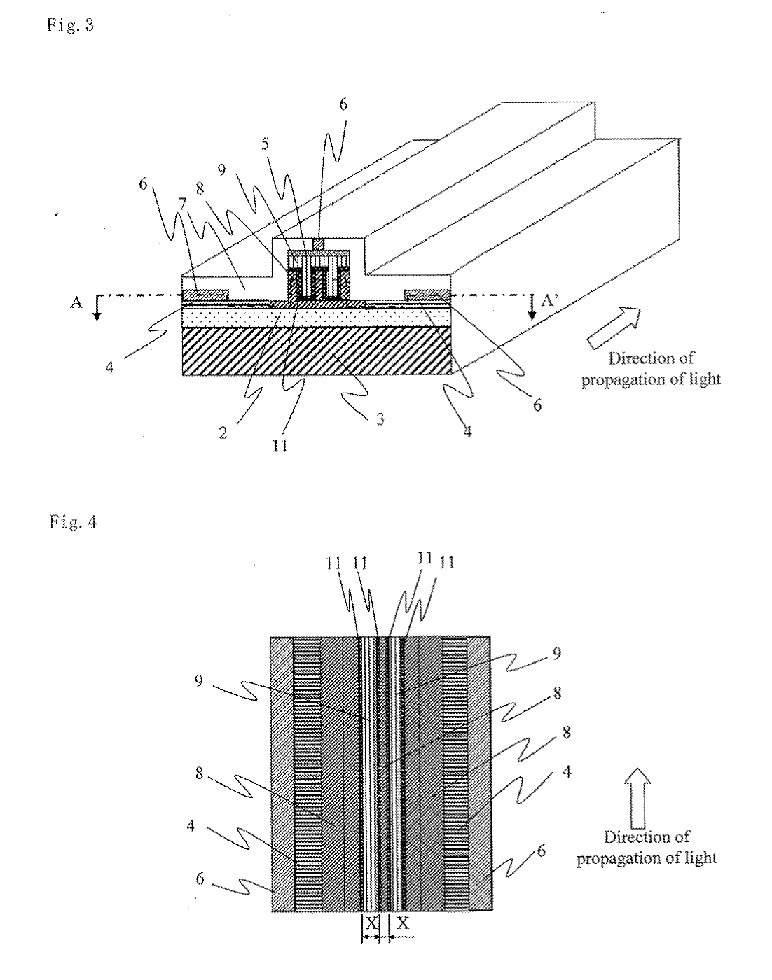

FIG. 3 is a schematic sectional view in an exemplary embodiment of the optical modulator according to the present invention. To describe the basic configuration of this optical modulator, embedded oxide layer 2 is formed on substrate 3, and over this layer, semiconductor 8 of a first conductivity having a rib construction, dielectric layer 11, and semiconductor layer 9 of a second conductivity are further layered in succession. The SOI substrate is made up of substrate 3, embedded oxide layer 2, and semiconductor 8 of the first conductivity. In the figure, the arrow shows the direction of propagation of light. Depressions in the direction orthogonal to the direction of propagation of light (the longitudinal direction of the depressions being parallel to the direction of propagation of light) are formed in the surface of semiconductor 8 of first conductivity (hereinbelow referred to as “p-doped semiconductor”) that makes up the rib waveguide formed on the SOI substrate to form an uneven form. All of the portions in which this uneven form is formed are then covered by thin (hereinbelow, “thin” indicates the submicron order (less than 1 μm)) dielectric layer 11. Semiconductor 9 of second conductivity (hereinbelow referred to as “n-doped semiconductor”) is further deposited on thin dielectric layer 11 to form rib shapes. Doped regions 4 that have undergone a doping process at high concentration (hereinbelow referred to as “p+-doped semiconductor”) are formed on the slab regions on both sides of the rib shapes, and a doped region 5 that has undergone a doping process at high concentration (hereinbelow referred to as “n+-doped semiconductor”) is also formed on semiconductor 9 of second conductivity. Electrode contact layers 6 are provided on each of p+-doped semiconductor 4 and n+-doped semiconductor 5. In addition, the entire waveguide is covered by oxide cladding 7.

In the construction of the present invention shown in FIG. 3, the provision of an uneven form at the junction interface of the capacitor construction enlarges the overlap of the optical field and the carrier density modulation region and allows sufficient modulation of light even when the optical modulation length is short, whereby the dimensions of the optical modulator can be reduced. In addition, further raising the doping density of the region that is doped to exhibit the first conductivity and the region that is doped to exhibit the second conductivity that are adjacent to the junction interface of the capacitor construction reduces the series resistance component and enables decrease of the RC time constant.

To reduce the light-absorption loss that results from the overlap between the optical field and these regions in which the doping density has been raised, the optical modulator of the present invention adopts the rib waveguide as shown in FIG. 3. In addition, adopting a construction in which the doping density of the slab regions is raised enables an optical modulator to be obtained that reduces light loss, decreases the RC time constant, and operates at high speed.

If W is the thickness of the portion in which carrier modulation occurs in the region close to the junction interface of the capacitor construction, the maximum depletion layer thickness (the thickness that brings about carrier modulation) W is given by the following expression in the thermal equilibrium state.

$$W = 2 \sqrt{\frac{{ɛ}_{s} kT ln ( \frac{{N}_{c}}{{n}_{i}} )}{{e}^{2} {N}_{c}}} \qquad [ Expression 4 ]$$

Here, ∈ₛ is the dielectric constant of the semiconductor layer, k is the Boltzmann constant, N_{c} is the carrier density, nᵢ is the intrinsic carrier concentration, and e is the charge amount. For example, when N_{c} is 10¹⁷/cm³, the maximum depletion layer thickness is in the order of 0.1 μm, and the depletion layer thickness, i.e., the thickness of the region in which modulation of the carrier density occurs, becomes thinner as the carrier density rises.

FIG. 4 is a sectional view taken along line AA′ of FIG. 3. If the spacing of the depressions and protrusions provided on p-doped semiconductor 8 is X, X is preferably no greater than 2 W. When the spacing of the depressions and protrusions is made no greater than 2 W, the carrier modulation regions between adjacent depressions and protrusions overlap, whereby a greater optical modulation effect is obtained. However, the effect of improving the optical modulation efficiency can be obtained even when the spacing between the depressions and protrusions of adjacent uneven forms is made equal to or greater than 2 W.

When the effective index of refraction in which the optical signal field is felt is n_{eff} and the optical signal wavelength is λ, the field size of light is λ/n_{eff}. As a result, the height from a depression to a protrusion provided on the surface of p-doped semiconductor 8 in the optical modulator shown in FIG. 3 is preferably no greater than λ/n_{eff}. Adopting this configuration causes the overlap between the optical field and the region in which carrier density modulation is effected to reach a maximum and enables the realization of efficient optical phase modulation.

FIG. 5 is a schematic view in another exemplary embodiment of the optical modulator of the present invention. In this exemplary embodiment, the uneven form is formed in the surface of the SOI layer in a direction that is orthogonal to the direction of light propagation. This optical modulator adopts a slab waveguide shape but has a rib construction in the opposite direction of the construction of FIG. 3 in the slab waveguide. Thin dielectric layer 11 is deposited on p-doped semiconductor 8 that has the uneven form, and n-doped semiconductor 9 is further deposited. The thicknesses of p- and n-doped semiconductors 8 and 9 that extend to the right and left for electrode leads is made no greater than 100 nm to reduce the size of the optical signal field. In this way, the regions of p+-doped semiconductor 4 and n+-doped semiconductor 5 that have undergone high-concentration doping processes can be arranged adjacent to the optical modulation region. This enables both the reduction of the series resistance component and the high-speed accumulation and elimination of carrier, thereby both reducing the size of the optical modulator and realizing higher speed and lower power. Electrode contact layers 6 are provided on p+-doped semiconductor 4 and n+-doped semiconductor 5. Portions other than p-doped semiconductor 8, dielectric layer 11, n-doped semiconductor 9, p+-doped semiconductor 4, n+-doped semiconductor 5, electrode contact layers 6, substrate 3 and embedded oxide layer 2 are covered by oxide cladding 7.

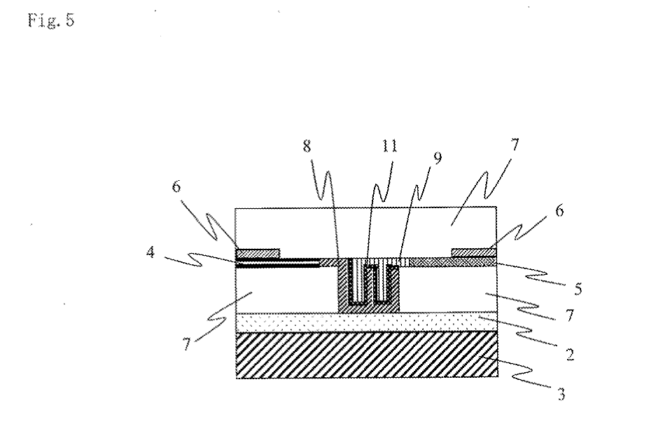

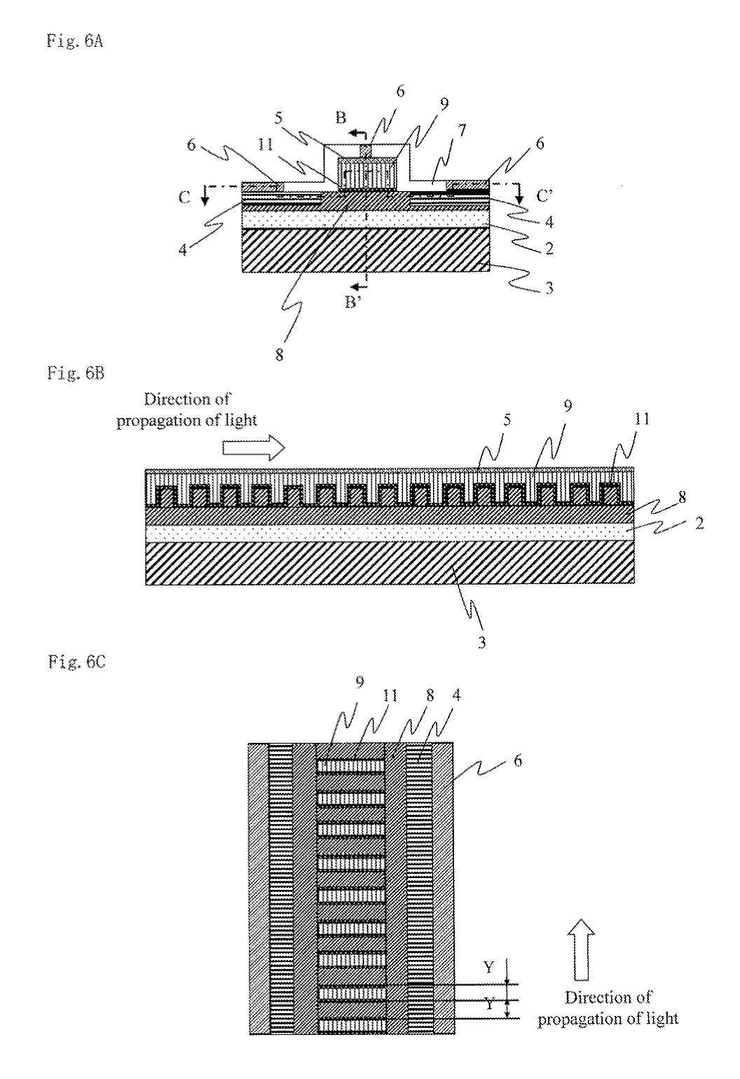

FIGS. 6A-6C are schematic views in yet another exemplary embodiment of the optical modulator of the present invention. FIG. 6A is a view as seen from the direction of the propagation of light, FIG. 6B is a view showing the cross-section at BB′ of FIG. 6A, and FIG. 6C is a view showing the cross-section at CC′ of FIG. 6A. The direction of the arrow is the direction of the propagation of light (a direction from the foreground and into the figure in FIG. 6A).

Depressions parallel to the direction of propagation of light (the longitudinal direction of the depressions being orthogonal to the direction of the propagation of light) are formed in the surface of p-doped semiconductor 8 in the rib waveguide formed on an SOI substrate to form an uneven form, and all portions on this uneven form are covered by thin dielectric layer 11. N-doped semiconductor 9 is deposited on this thin dielectric layer 11. N+-doped semiconductor 5 that has undergone a high-concentration doping process is further deposited on this n-doped semiconductor 9. P+-doped semiconductor 4 that has undergone a high-concentration doping process is formed on the slab regions on both sides of the region formed in rib shapes. Electrode contact layers 6 are provided on p+-doped semiconductor 4 and n+-doped semiconductor 5, and the entire waveguide is further covered by oxide cladding 7.

If Y is the spacing of the depressions and protrusions of the uneven form that is formed on p-doped semiconductor 8 and W is the thickness of the region in which the carrier density is modulated, Y is preferably no greater than 2 W for the reasons described hereinabove. In addition, the period of the uneven form may be set to delay the group speed of optical signals, or may be set to a spacing that is no greater than λ/n_{eff} to suppress the reflection of the optical signals, where n_{eff} is the effective index of refraction in which the optical signal field is felt nonperiodically and λ is the optical signal wavelength.

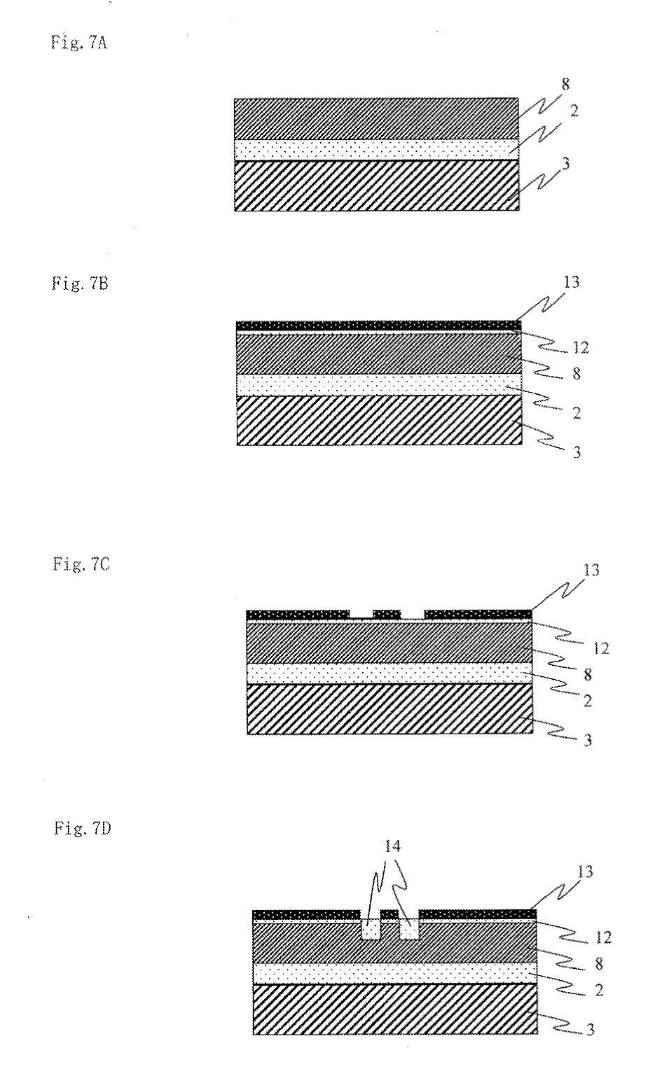

FIGS. 7A to 9 show an example of a method of the present invention for forming a carrier modulation region having an uneven form.

FIG. 7A is a sectional view of the SOI substrate that is used for forming the optical modulator of the present invention. This SOI substrate is constituted by a construction in which embedded oxide layer 2 is laminated on substrate 3 and silicon layer 8 in the order of from 100 to 1000 nm (1 μm) is further laminated on embedded oxide layer 2. The thickness of embedded oxide layer 2 is set to at least 1000 nm (1 μm) to reduce light loss. Silicon layer 8 on this embedded oxide layer 2 may employ a substrate that has undergone a doping process beforehand to exhibit the first conductivity or may be subjected to a heat treatment following a process of doping phosphorus or boron on the silicon surface layer by, for example, ion implantation. In FIG. 7A, it is assumed that boron is doped and that silicon layer 8 is a p-doped semiconductor.

Next, as shown in FIG. 7B, thermal oxidation layer 12 in the order of from 10 to 30 nm is formed by heat treatment on p-doped semiconductor 8, and SiNₓ layer 13 is formed on thermal oxidation layer 12 by a film-forming method such as a low-pressure CVD (Chemical Vapor Deposition) method.

Next, as shown in FIG. 7C, SiNₓ layer 13 is patterned to form spacing that corresponds to the spacing of the depressions and protrusions of the uneven form formed on p-doped semiconductor 8.

As shown in FIG. 7D, a thermal oxidation process is carried out with the SiNₓ layer that was patterned in FIG. 7C as a mask to form thermal oxidation layer 14 on the portions of p-doped semiconductor 8 layer that were not masked. This process is called a LOCOS (Location Oxidation of Semiconductor) process, and although this is a typical process in CMOS processing, the control of form is not adequate when microprocessing in the order of 100 nm or less. Accordingly, forming the uneven form of desired surfaces by a method such as reactive ion etching with a photoresist as a mask in place of the LOCOS process is also effective.

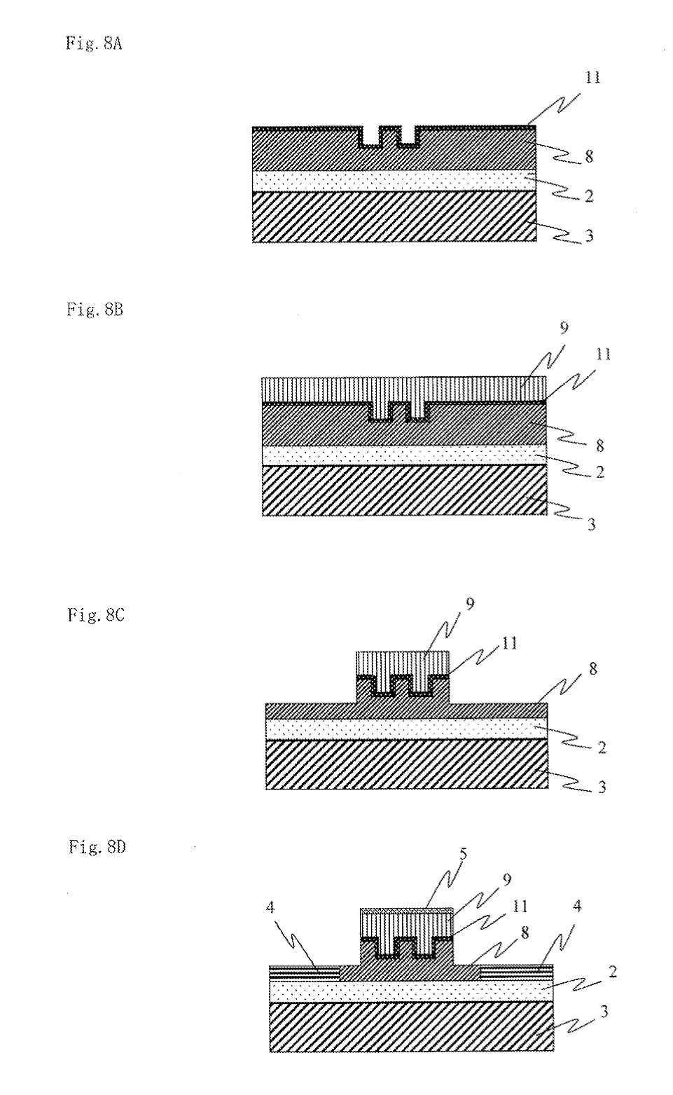

The SOI substrate is next immersed in a phosphate solution to remove SiNₓ layer 13 and thermal oxidation layers 12 and 14, following which a heat treatment is carried out to form the silicon oxide layer that is dielectric layer 11 on the surface layer of p-doped semiconductor 8, as shown in FIG. 8A. Dielectric layer 11 should be at least one layer composed of a silicon oxide layer, a silicon nitride layer, or another high-k insulating layer.

Next, as shown in FIG. 8B, polycrystalline silicon 9 is formed by a CVD method or a sputtering method such that the uneven form on the surface of dielectric layer 11 is sufficiently covered. At this time, the uneven form of dielectric layer 11 produces a similar uneven form that is formed on polycrystalline silicon 9. This uneven form on polycrystalline silicon 9 may cause light scattering loss at the time of transmitting optical signals and is therefore preferably smoothed by a CMP (Chemical-Mechanical Polishing process). In addition, polycrystalline silicon 9 is subjected to a doping process during film formation or an ion implantation method following the film formation with boron or phosphorus (a doping process with the opposite component of the semiconductor layer of the first conductivity) to exhibit the second conductivity. In FIG. 8B, a doping process with phosphorus is assumed and polycrystalline silicon 9 is assumed to be an n-doped semiconductor.

Next, as shown in FIG. 8C, the laminated body shown in FIG. 8B is processed to a rib form by means of, for example, a reactive plasma etching method such that the width (rib width) of the optical waveguide construction is no greater than from 0.3 μm to 2 μm. Further, as shown in FIG. 8(d), p+-doped semiconductor 4 and n+-doped semiconductor 5 that have been subjected to a high-concentration doping process are formed in the regions adjacent to p-doped semiconductor 8 and n-doped semiconductor 9.

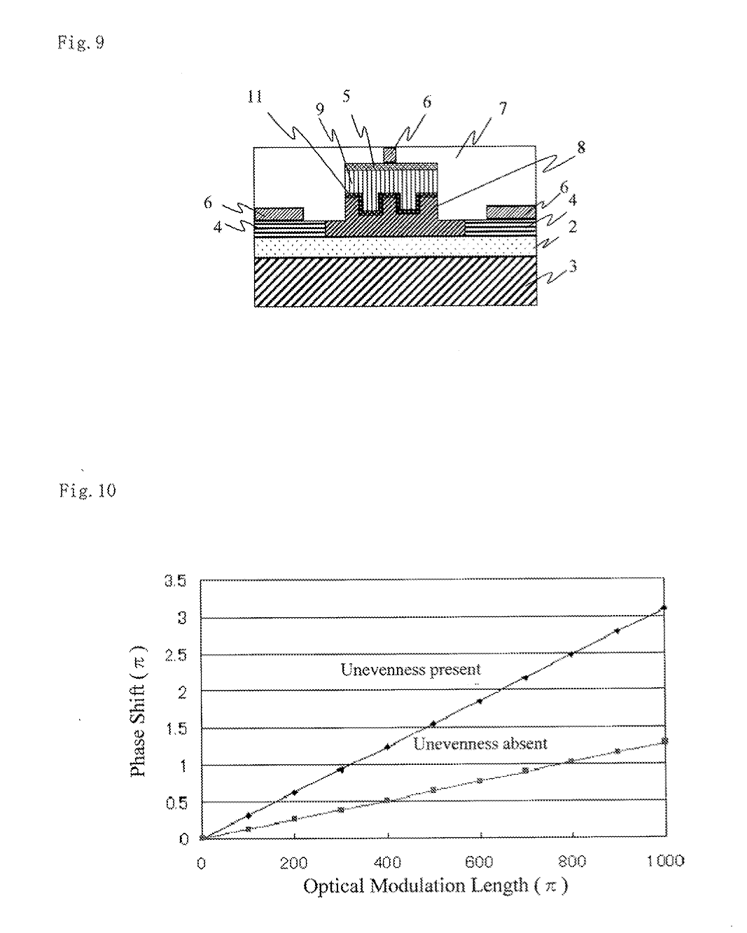

Finally, as shown in FIG. 9, electrode contact layers 6 composed of, for example, TaN/Al (Cu) are formed and connected with a drive circuit. Oxide cladding layer 7 is then formed.

In the present invention, a semiconductor of a first conductivity and a semiconductor of a second conductivity are made up of at least one layer selected from the group made up of polycrystalline silicon, amorphous silicon, strained silicon, single-crystal Si, and SiₓGe₍₁₋ₓ₎.

The dependence of the amount of phase shift on the length in the direction of optical signal propagation in the optical modulator of the present invention was investigated for a case in which an uneven form is present on the surface of semiconductor layer 8 of the first conductivity and for a case in which there is no uneven surface. The spacing of the depressions and protrusions of the uneven form was set to 160 nm or less. An example of the experimental results is shown in FIG. 10.

It was understood that the optical modulation efficiency is improved because the amount of phase shift is increased by forming an uneven form in which the spacing between depressions and protrusions is no greater than approximately 160 nm, which is of the same order as the thickness at which carrier is modulated. Although the experimental results are not shown regarding the height from depressions to protrusions, the optical modulation efficiency was improved by increasing the height.

The relation between the carrier density and the operating frequency band of optical modulation of the optical modulator was also investigated for a case in which an uneven form is present on the surface of semiconductor 8 of first conductivity and for a case in which there is no uneven surface. Regarding the operating frequency band of optical modulation, there is a trade-off between the effect of reducing the size due to the improvement of modulation efficiency and the influence of the increase in electric capacity due to providing an uneven form. When the spacing between depressions and protrusions of the uneven form is made no greater than 160 nm, the effective index of refraction in which the optical signal field is felt is set to n_{eff}, and the optical signal wavelength is set to λ, the operating frequency band of optical modulation broadens when the height from a depression to a protrusion is no greater than λ/n_{eff}.

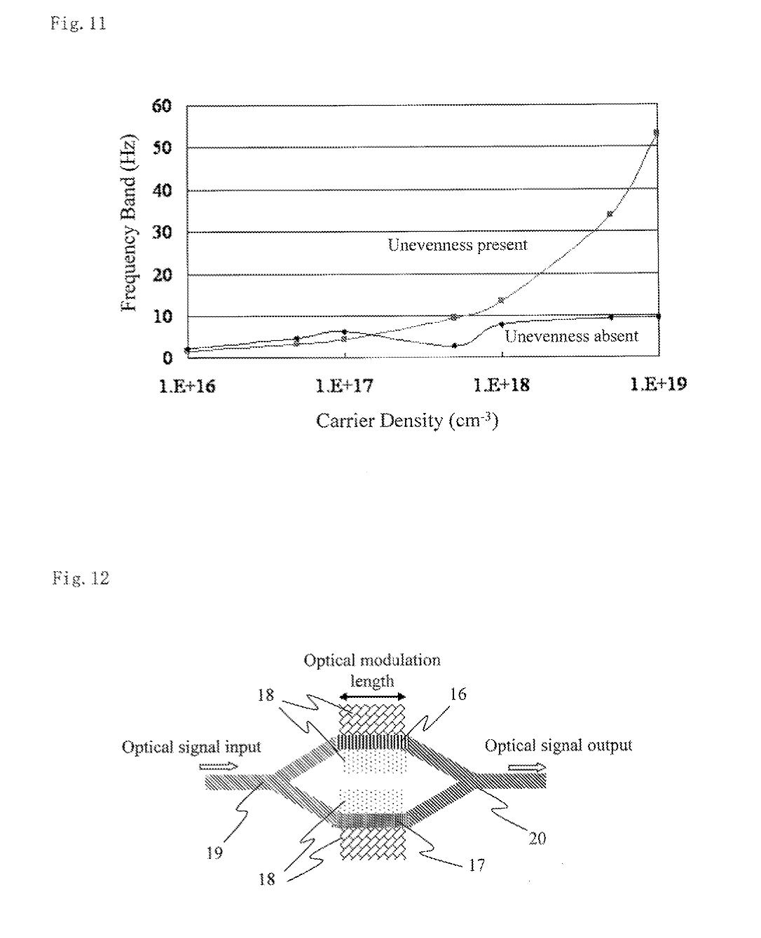

As can be understood from the example of the experimental results shown in FIG. 11, setting the carrier density to the order of 10¹⁸/cm³ makes the operating frequency band of optical modulation at least 10 GHz and enables high-speed operation.

In addition to the above points, the mobility and life of the carrier are crucial to the improvement of the frequency band. In particular, the mobility of the carrier in a polycrystalline silicon layer can be raised as an issue in high-speed operation. It is therefore effective to increase the particle diameter through recrystallization by means of an annealing process to improve the carrier mobility, or relating to semiconductor 9 of the second conductivity, to use, for example, an epitaxial lateral overgrowth (ELO) method to improve the crystalline quality.

Finally, an example of the application of the optical modulator of the present invention is next described.

FIG. 12 shows the construction of a Mach-Zehnder interferometer light intensity modulator that applies the optical modulator of the present invention. By using a Mach-Zehnder interferometer, a light intensity modulation signal can be obtained by bringing about interference of optical phase difference at the two arms of the Mach-Zehnder interferometer.

First arm 16 and second arm 17 have optical modulators which are arranged in parallel to each other, each of arms 16 and 17 being connected to optical branching construction 19 that branches first arm 16 and second arm 17 on the input side and being connected to optical coupling construction 20 that joins first arm 16 and second arm 17 on the output side. Subjecting the light that is branched by optical branching construction 19 to phase modulation in first arm 16 and second arm 17 and to phase interference by optical coupling construction 20 converts the light to an optical intensity modulated signal.

In the present working example, optical branching construction 19 arranged on the input side causes input light to be equally distributed between first arm 16 and second arm 17. In addition, the application of a plus voltage to first arm 16 by electrode pads 18 brings about carrier accumulation on both sides of the thin dielectric layer of the optical modulator, and the application of a minus voltage to second arm 17 brings about the elimination of the carrier on both sides of the thin dielectric layer of the optical modulator. In this way, the index of refraction in which the optical signal field in the optical modulator is felt becomes smaller in the carrier accumulation mode, and in the carrier elimination (depletion) mode, the index of refraction in which the optical signal field is felt becomes larger and the optical signal phase difference on the two arms reaches a maximum. Multiplexing the optical signals that are transmitted though these two arms by means of the optical coupling construction on the output side brings about optical intensity modulation. It was confirmed that an optical signal of at least 20 Gbps can be transmitted in a Mach-Zehnder interferometer optical intensity modulator that uses the optical modulator of the present invention.

In addition, the present invention can further be applied to, for example, an optical modulator that has a higher transfer rate or to a matrix optical switch by arranging a plurality of optical intensity modulators of Mach-Zehnder interferometer construction that use optical modulators in parallel or in series.

This application claims priority based on Japanese Patent Application Number 2008-290903, for which application was submitted on Nov. 13, 2008, and further incorporates all of the disclosures of that application.

1. An optical modulator comprising:
a semiconductor layer that has an uneven form and that has undergone a doping process to exhibit a first conductivity;
a semiconductor layer that has undergone a doping process to exhibit a second conductivity; and
a dielectric layer formed on an uneven form of said semiconductor layer of first conductivity and interposed between at least a portion of said semiconductor layer of first conductivity and at least a portion of said semiconductor layer of second conductivity.

2. The optical modulator as set forth in claim 1, wherein said uneven form of the surface of said semiconductor layer of first conductivity is formed in a direction perpendicular to the direction of propagation of optical signals.

3. The optical modulator as set forth in claim 1, wherein said uneven form of the surface of said semiconductor layer of first conductivity is formed in a direction parallel to the direction of propagation of optical signals.

4. The optical modulator as set forth in claim 1, wherein the spacing between depressions and protrusions of said uneven form of the surface of said semiconductor layer of first conductivity is no greater than 2 W with respect to thickness W of regions in which free carrier is accumulated, eliminated, or inverted on both sides of said dielectric layer in each of said semiconductor layer of first conductivity and said semiconductor layer of second conductivity.

5. The optical modulator as set forth in claim 1, wherein the height from depressions to protrusions of said uneven form of the surface of said semiconductor layer of first conductivity is no greater than λ/n_{eff} where λ is the optical signal wavelength and n_{eff} is the effective index of refraction in which the optical signal field is felt in said optical modulator.

6. The optical modulator as set forth in claim 1, wherein regions in which the optical signal field has a peak intensity are arranged in regions in which free carrier is accumulated, eliminated, or inverted at both sides of said dielectric layer.

7. The optical modulator as set forth in claim 1, wherein said semiconductor layer of first conductivity and said semiconductor layer of second conductivity are composed of at least one layer of polycrystalline silicon, amorphous silicon, strained silicon, single-crystal Si, and SiₓGe₍₁₋ₓ₎.

8. The optical modulator as set forth in claim 1, wherein regions that propagate optical signals that include portions in which said semiconductor layer of first conductivity and said semiconductor layer of second conductivity overlap with said dielectric layer interposed are of a rib waveguide construction.

9. The optical modulator as set forth in claim 1, wherein regions that propagate optical signals that include portions in which said semiconductor layer of first conductivity and said semiconductor layer of second conductivity overlap with said dielectric layer interposed are of a slab waveguide construction.

10. An optical intensity modulator, comprising:
the optical modulators as set forth in claim 1;
a first arm in which a said optical modulator is arranged and a second arm in which a said optical modulator is arranged that constitute a Mach-Zehnder interferometer construction;
an optical branching construction that joins said first arm and said second arm on the input side; and
an optical coupling construction that couples said first arm and said second arm on the output side.

11. The optical intensity modulator as set forth in claim 10, wherein said optical branching construction gives a one-to-one input signal distribution ratio to said first arm and said second arm.

12. The optical intensity modulator as set forth in claim 10, wherein a plurality of said Mach-Zehnder interferometer constructions are arranged.

13. The optical intensity modulator as set forth in claim 12, wherein a plurality of said Mach-Zehnder interferometer construction is arranged in parallel or in a series.

14. An optical modulator fabrication method, comprising steps of:
providing an uneven form on the surface of a semiconductor layer that has undergone a doping process to exhibit a first conductivity;
forming said dielectric layer on said uneven form of said semiconductor layer of first conductivity; and
forming a semiconductor layer that has undergone a doping process to exhibit a second conductivity such that at least a portion of said semiconductor layer of second conductivity overlaps said dielectric layer.

15. The optical modulator fabrication method as set forth in claim 14, wherein said uneven form of the surface of said semiconductor layer of first conductivity is formed in a direction perpendicular to the direction of propagation of optical signals.

16. The optical modulator fabrication method as set forth in claim 14, wherein said uneven form of the surface of said semiconductor layer of first conductivity is formed in a direction parallel to the direction of propagation of optical signals.

17. The optical modulator fabrication method as set forth in claim 14, wherein the spacing of depressions and protrusions of said uneven form of the surface of said semiconductor layer of first conductivity is made no greater than 2 W with respect to thickness W of regions in which free carrier is accumulated, eliminated, or inverted on both sides of said dielectric layer in each of said semiconductor layer of first conductivity and said semiconductor layer of second conductivity.

18. The optical modulator fabrication method as set forth in claim 14, wherein the height from a depression to a protrusion of said uneven form of the surface of said semiconductor layer of first conductivity is made no greater than λ/n_{eff} where λ is the optical signal wavelength and n_{eff} is the effective index of refraction in which the optical signal field is felt in said optical modulator.

19. The optical modulator fabrication method as set forth in claim 14, wherein regions in which the optical signal field has peak intensity are arranged in regions in which free carrier is accumulated, eliminated, or inverted on both sides of said dielectric layer.

20-21. (canceled)
